(19) United States
(12) Patent Application Publication
(10) Pub. No.: US 2004/0216620 A1
(43) Pub. Date: Nov. 4, 2004

(54) Lock and drain cooking system

(75) Inventors: James H. Quiggins, Houston, TX (US); Antonio J. Galafassi, Houston, TX (US)

Correspondence Address: CONLEY ROSE, P.C., P. O. BOX 3267, HOUSTON, TX, 77253-3267, US

(73) Assignee: Tramontina USA, Inc., Sugar Land, TX

(21) Appl. No.: 10/621,815

(22) Filed: Jul. 17, 2003

Related U.S. Application Data
(60) Provisional application No. 60/466,942, filed on Apr. 30, 2003.

(51) Int. Cl. A47J 37/12

(52) U.S. Cl. 99/413; 99/417

(57) ABSTRACT

An apparatus and method for cooking and straining food items is described herein. The cooking apparatus has a vessel with an annular rim and an insert supported in rotational engagement with the vessel and having an annular rim portion engaging the vessel rim, where the insert rim is configured to rotationally engage the vessel rim such that when the insert is engaged with the vessel, the insert remains engaged with the vessel as the insert is rotated relative to the vessel. The vessel and insert rims of the cooking apparatus may further include hooks and cutouts for securing the insert onto the vessel. The method described herein includes positioning the hooks in the cutouts, rotating the insert so as to lock it onto the pot, cooking and straining food items, and realigning the hooks and cutouts to remove the insert from the pot.

### CROSS-REFERENCE TO RELATED APPLICATIONS

The present application claims the benefit of U.S. Provisional Application Serial No. 60/466,942 filed Apr. 30, 2003, entitled Lock and Drain Cooking System, which is hereby incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention is related to cookware useful for both cooking and straining. More particularly, the preferred embodiments of the present invention are directed to a cookware system for cooking contents eventually required to be strained and separated from the liquid in which the cooking occurs. Still more particularly, the preferred embodiments are directed to a cookware system that functions as both the cooking vessel and the straining device.

2. Background of the Invention

Food preparation often requires the cook to heat and/or strain food items. For example, pasta prepared in boiling water must be strained from the water before being incorporated in a dish or served. Another example is the preparation of ground beef: while browning the ground beef, liquid fat is produced which typically must be strained from the cooking vessel before the beef is used in a dish or served. In other examples, food items may need to be separated from a liquid for a variety of reasons, whether it is beans or potatoes that need to be separated from the water they have soaked in, or whether it is a soup stock where the liquid stock is drained away, leaving the solid food items behind.

Typically, food items are strained by employing utensils separate from the cooking vessel, such as a colander or hand-held straining spoon or spatula. However, the use of separate utensils to perform different functions increases the awkwardness and inefficiency of food preparation. Moreover, separate conventional strainers and colanders tend to use more space in storage and in the dishwasher. The industry would welcome a cookware system including a vessel having a removable straining device which maximizes the ease of engagement with and removal of the strainer from the cooking vessel, while also providing great flexibility of movement and use while engaged with the cooking vessel. The industry would also welcome a coordinated system including a cooking vessel, straining device, and vessel lid where these components are designed specifically to work together to provide a flexible and reliable cooking and straining system.

### BRIEF SUMMARY OF SOME OF THE PREFERRED EMBODIMENTS

The problems noted above are addressed in large part by a cooking apparatus having a vessel with an annular rim, an insert supported in rotational engagement with the vessel and having an annular rim portion engaging the vessel rim, where the insert rim is configured to rotationally engage the vessel rim such that when the insert is engaged with the vessel, the insert remains engaged with the vessel as the insert is rotated relative to the vessel in an arc not less than 45 degrees. The cooking apparatus may further include a lid where the vessel has a shoulder having a diameter to support the insert and the lid simultaneously, or alternatively, to support the lid when the insert is not used.

In another embodiment of the invention, the cooking apparatus has a vessel with an annular rim; a strainer insert supported in rotational engagement with the vessel and having an annular rim portion engaging the vessel rim; a latch member attached to and extending from one of the rims and capturing the other of the rims; at least one cutout in the other of the rims; where the insert is detachable from the vessel when the latch member is aligned with the cutout; and where the insert is rotatable relative to the vessel when the latch member is aligned and when not aligned with the cutout.

In a further embodiment of the invention, the cooking apparatus has a cooking vessel having a first rim, an insert having a second rim resting upon the first rim and where the insert has a region of straining apertures and an access aperture, a cutout in at least one of the rims, and a hook member extending from the other of the rims where the hook member has a crevice receiving the rim having the cutout and locking the insert to the vessel when the hook and cutout are not aligned. The hook member has a C-shaped cross-section.

A method according to the present invention includes providing a pot having a rim with a plurality of cutouts; providing a strainer insert having a rim with a plurality of hooks; positioning the hooks in the cutouts and supporting the strainer insert on the pot; rotating the strainer insert such that the hooks do not align with the cutouts so as to lock the strainer insert onto the pot; cooking the food items; and straining the food items. The method may further include realigning the hooks and cutouts and removing the strainer from the pot.

It is an important objective of the present invention to provide an improved combined food cooker and strainer.

It is a further objective of the present invention to provide for a food strainer that may be detachably secured to an ordinary cooking vessel, such as a pot or pan, while still accommodating the cover for the pot or pan.

It is still a further objective of the present invention to provide for a food strainer that securely attaches to a cooking vessel without the need for bulky or awkward engagement or locking mechanisms, such that the food strainer and cooking vessel work together, and such that the lid serves as a closure to the cooking vessel, with and without the food strainer connected to the vessel.

It is yet another objective of the present invention to provide for a food strainer that permits access to the contents of the cooking vessel while remaining engaged with the cooking vessel.

It is still a further objective of the present invention to provide for a cooking vessel and detachable food strainer with a locking mechanism that securely attaches the food strainer to the cooking vessel, but that is also relatively easy to fabricate, install, and remove while cooking, and that allows movement of the strainer relative to the cooking vessel while engaged with the vessel.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 shows an exploded, perspective view of a preferred embodiment of the lock and drain cooking system of the present invention;

FIG. 2 shows a perspective view of the lock and drain cooking system of FIG. 1 with the strainer in the engaged and locked position on the cooking vessel without the lid;

FIG. 3 shows a top, elevational view of the cooking system of FIG. 2;

FIG. 4 shows a partial cross-sectional view of the engagement and locking mechanism of the cooking system of FIG. 1 showing the strainer in the engaged and locked position on the vessel, and with the lid on the vessel;

FIG. 5 shows a side, elevational view of the cooking system of FIG. 1 with the strainer in the engaged and locked position on the vessel, and with the lid atop the vessel; and

FIG. 6 shows a top, elevational view of the cooking vessel without the strainer or lid;

FIG. 7 shows a perspective view of a hook and cutout portion of the strainer and cooking vessel of FIG. 1;

FIG. 8 shows a perspective view of a hook and cutout portion of an alternative embodiment of the strainer and cooking vessel wherein the strainer has the cutout and the cooking vessel has the hook;

FIG. 9 shows an exploded, perspective view of an alternative embodiment of the cooking system shown in FIG. 1; and

FIG. 10 shows a side, elevational view in partial cross-section of the cooking system of FIG. 9.

### NOTATION AND NOMENCLATURE

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct mechanical connection. Thus, if a first device couples to a second device, that connection may be through a direct mechanical connection, or through an indirect mechanical connection via other devices and connections.

This exemplary disclosure is provided with the understanding that it is to be considered an exemplification of the principles of the invention, and is not intended to limit the invention to that illustrated and described herein. In particular, various embodiments of the present invention provide a number of different constructions and methods of operation. It is to be fully recognized that the different teachings of the embodiments discussed below may be employed separately or in any suitable combination to produce desired results.

### DETAILED DESCRIPTION OF THE PREFERRED EMBODIMENTS

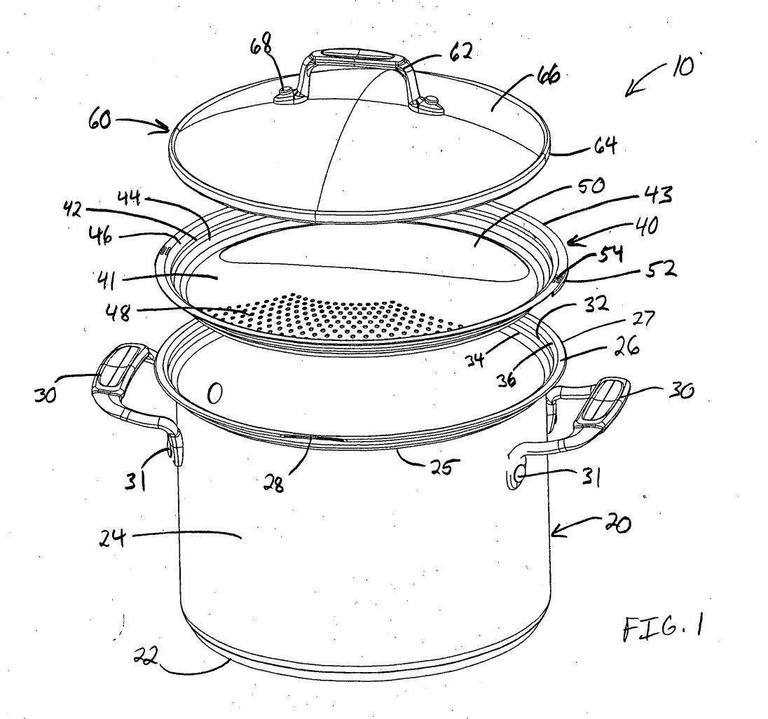

The preferred embodiment described herein generally discloses a cooking system having a cooking vessel and a detachable straining device that can be secured to the cooking vessel such that the cooking vessel may be used for both cooking and straining food items. The full scope of the preferred embodiment is described below in conjunction with related FIGS. 1-5. However, the discussion below is meant to be illustrative of the principles and various embodiments of the present invention. While the preferred embodiment of the invention and its method of use are shown and described, modifications thereof can be made by one skilled in the art without departing from the spirit and teachings of the invention. The embodiments described herein are exemplary only, and are not limiting. Many variations and modifications of the invention and apparatus and methods disclosed herein are possible and are within the scope of the invention. For example, the cooking vessel is shown as an ordinary cooking pot, but the vessel may be any cookware used to contain, store, prepare, or cook food items. Furthermore, the engagement and locking means, generally shown and described as part of the rim portions of the pot and strainer insert, may be embodied numerous ways such that the pot and strainer insert work together to provide a securely fastened straining apparatus in accordance with the teachings of the present invention.

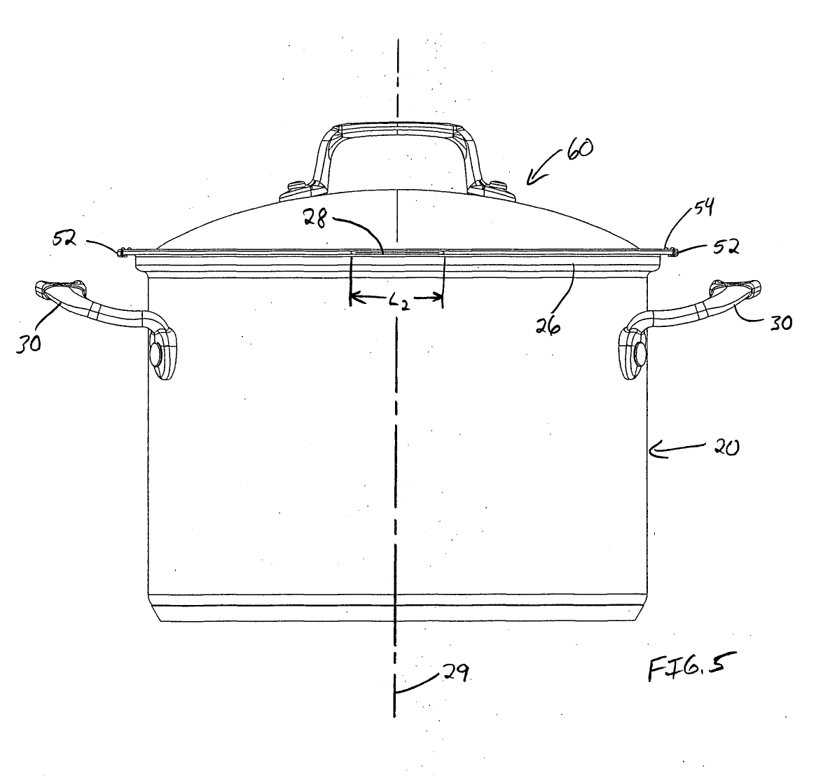

Referring first to FIG. 1, the lock and drain cooking system 10 is shown having a cooking vessel or pot 20, a strainer insert 40, and lid 60. Pot 20 has a base portion 22, a body portion 24, and an annular rim projection or flange 26. Pot 20 has a longitudinal axis 29, best seen in FIG. 5. Coupled to the body portion 24 of pot 20 are handles 30, held in place by fasteners such as rivets 31. Pot 20 and handles 30 may be made from any suitable materials, with premium 18/10 stainless steel being preferred for pot 20 and cast stainless steel being preferred for handles 30. Pot 20 may also vary in size and shape.

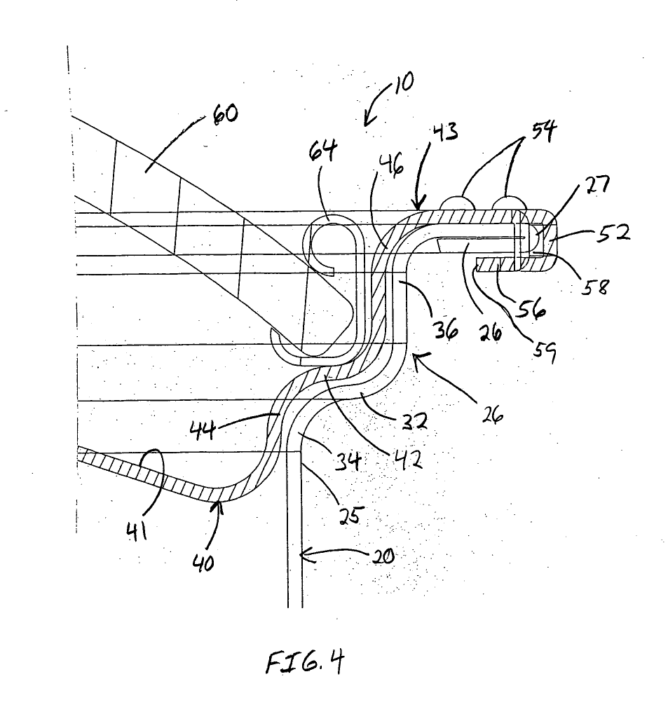

As best shown in FIG. 4, flange 26 of pot 20 joins body portion 24 at junction 25. Flange 26 extends upward and radially outward from junction 25. Between junction 25 and the terminal end 27 of flange 26 is first step 34 and second step 36. Flange 26 may be configured to include additional steps if desired. Steps 34, 36 form a shoulder 32. Steps 34, 36 and shoulder 32 are the engagement and support means for insert 40 and lid 60. Although FIG. 4 shows cooking system 10 having strainer insert 40 positioned between pot 20 and lid 60, strainer insert 40 can be removed without affecting the use of lid 60 in conjunction with pot 20. It can be seen in FIG. 4 that shoulder 32 comprises a diameter configured to support lid 60 even when strainer insert 40 is not used.

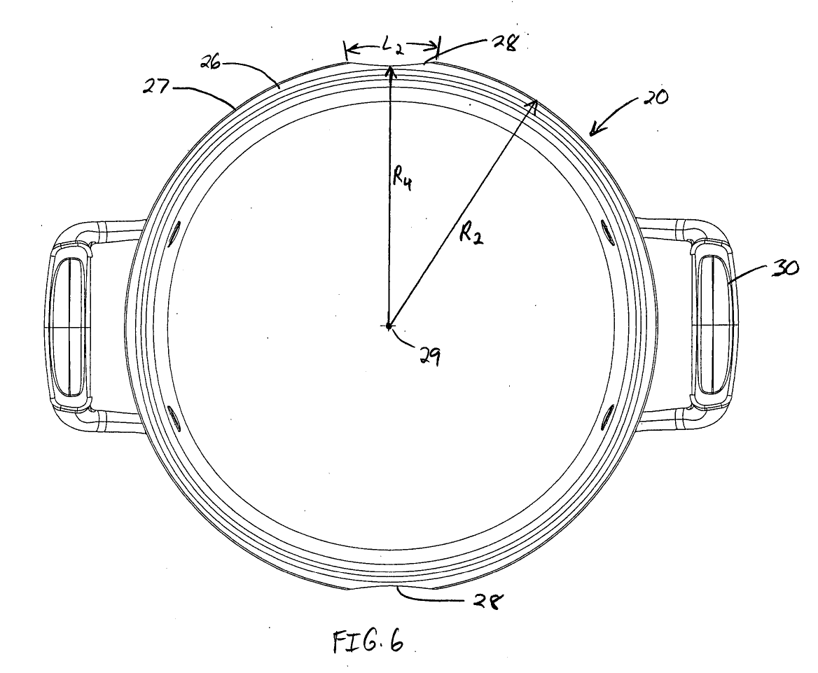

As best shown in FIG. 6, annular rim projection or flange 26 also includes cutouts 28 at certain locations along the circumference of terminal end 27. The embodiment shown in FIG. 6 includes two cutouts 28 located at opposing locations of flange 26. Flange 26 may include more or fewer than two cutouts 28, and they may be located at differing positions about flange 26.

Referring again to FIG. 1, strainer insert 40 is generally disk-shaped and preferably made from premium 18/10 stainless steel, but can be made of any other suitable material. Strainer insert 40 includes a raised main body portion 41 (see FIG. 4), an access aperture 50 on one side of insert 40, a region of straining apertures 48 on the other side of insert 40, and a raised outer edge portion or rim 43. Rim 43 includes a series of graduated steps. In this preferred embodiment, rim 43 is shown with a first step 44 and a second step 46, which together form a shoulder 42 having a diameter to support lid 60 when the strainer insert is used with cooking system 10, as best shown in FIG. 4. Steps 44, 46 and shoulder 42 are configured such that their outer surfaces engage and mate with the inner surfaces of steps 34, 36 and shoulder 32 of pot 20 when insert 40 engages pot 20. Shoulders 32 and 42 should have diameters such that lid 60 is supported in a similar fashion whether strainer insert 40 is used (as seen in FIG. 4), or whether lid 60 simply sits atop pot 20. As will be understood, pot 20 and insert 40 may be made with fewer or more steps 34, 36, 44, and 46.

Latch or hook members 52 are disposed at opposing locations on the underside of rim 43 of strainer insert 40, and are substantially C-shaped in cross-section, as seen in FIG. 4. Hooks 52 include a locking or capture portion 56 having a terminal end 59, the capture portion 56 partly providing the cross-sectional C-shape of hook 52. Included on the inside of C-shaped hook 52 is a crevice 58. Insert 40 may have more or fewer than two hooks 52, and the number of hooks 52 may or may not correspond to the number of cutouts 28. Hooks 52 may be positioned anywhere along the circumference of rim 43. However, it is preferred that hooks 52 be disposed at locations between aperture 50 and the region of straining apertures 48, such positioning will facilitate straining of the contents of pot 20, as will be explained hereinafter. On the upper surface of edge portion 43 just above latches 52, are two sets of a plurality of nodes 54.

Lid 60 is also shown in FIG. 1 having a body portion 66 made from tempered glass, making lid 60 substantially see-through, a rim 64 made from reinforced 18/10 stainless steel, and a knob 62 made from cast stainless steel and riveted to body portion 66 by rivets 68. Body portion 66, rim 64, and knob 62 of lid 60 may also be made of any other suitable materials, with body portion 66 preferably made of a see-through material for viewing the pot contents during use of cooking system 10.

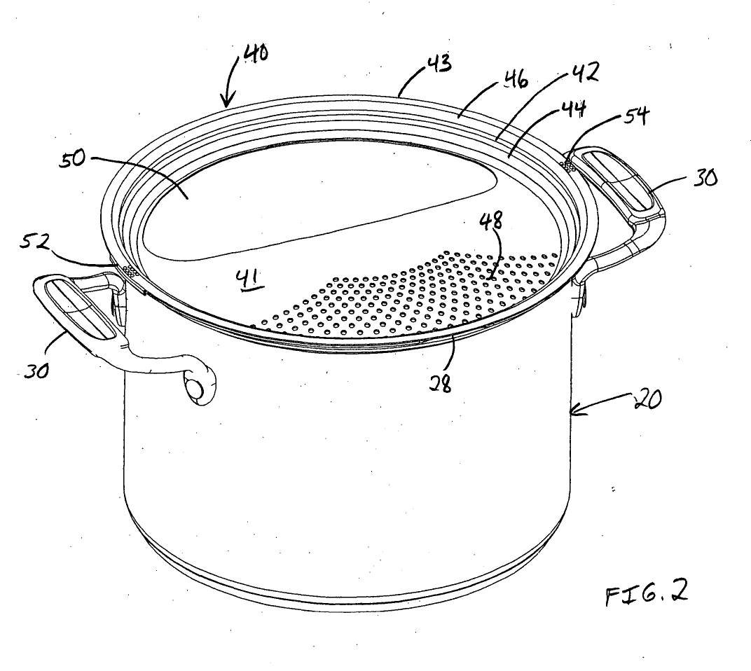

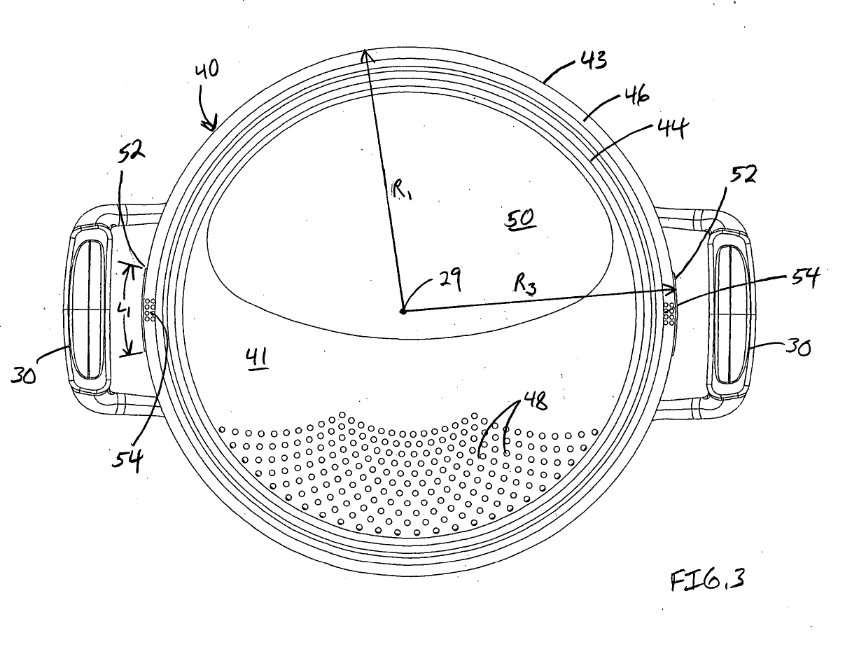

Referring now primarily to FIGS. 2-5, strainer insert 40 is shown in an engaged and locked position with respect to pot 20. Before insert 40 can be properly secured onto pot 20, hooks 52 must be aligned with cutouts 28. As insert 40 is lowered onto flange 26 (FIG. 1) of pot 20, capture portion 56 of hook 52 (FIG. 4) passes through cutout 28. The arcuate length L₂ of cutout 28 (FIGS. 5 and 6) will be slightly greater than the arcuate length L₁ of hook 52 (FIG. 3) so that locking portion 56 can easily pass through cutout 28. As can be seen in FIG. 4, locking portion 56 would interfere with the terminal end 27 of flange 26 if it were not for the presence of cutouts 28. If latches 52 and cutouts 28 are properly aligned as insert 40 is lowered onto the top of pot 20, steps 44, 46 and shoulder 42 of rim 43 of insert 40 will engage steps 34, 36 and shoulder 32 of pot 20, respectively, as shown in FIG. 4.

Arcuate lengths L₁ and L₂ preferably are configured to comprise a small percentage of the total circumferences of terminal end 27 of flange 26 and rim 43 of insert 40, respectively. For example, in the preferred embodiment, terminal end 27 and rim 43 may both have circumferences of 33 inches. Arcuate length L₁ of latch 52 may be approximately 1.625 inches and arcuate length L₂ of cutout 28 may be approximately 2 to 2.25 inches. Expressed as percentages, L₁ is about 5% of the circumference of terminal end 27 and L₂ is about 6 to 6.8% of the circumference of rim 43. Although the arcuate lengths L₁ and L₂ are given by way of example, the percentages represent the preferred lengths of the latches and cutouts relative to the rim portions of the insert and pot of this embodiment.

Referring briefly to FIG. 4, a partial cross-section of cooking system 10 is shown including hook 52 of insert 40. It can be seen that flange 26 of pot 20 is configured to support strainer insert 40 at its raised edge portion 43. Steps 34, 36 and shoulder 32 of pot 20 mate with similarly-shaped steps 44, 46 and shoulder 42 of insert 40. In the locked or captured position shown in FIG. 4, terminal end 27 is disposed within crevice 58 formed by hook 52, whereby hook 52 has captured flange 26 of pot 20. Flange 26 then provides some support for insert 40. Lid 60 includes a rim 64 having a diameter to rest atop shoulder 42 if strainer insert 40 is in place as shown in FIG. 4, or if strainer insert 40 is not being used, rim 64 having the same diameter will rest atop shoulder 32 of pot 20. Step 46, or, alternatively, step 36, prevents lid 60 from moving laterally with respect to insert 40.

As best shown in FIG. 3, radius R₁ of insert 40 is the distance from longitudinal axis 29 to the end of rim 43 and radius R₃ is the distance from axis 29 to the end of hook 52. Radius R₃ is slightly greater than radius R₁ as the end of hook 52 extends slightly beyond the end of rim 43. As seen in FIG. 6, pot 20 has a radius R₂ at the terminal end 27 of flange 26 and a radius R₄ at cutout 28. Radius R₁ of insert 40 is substantially the same as radius R₂ of pot 20. As further seen in FIG. 4, radius R₃ of insert 40 at hook 52 is slightly larger than radius R₁ at terminal end 27 so that crevice 58 may accommodate terminal end 27. Locking portion 56 is provided so that C-shaped hook 52 captures flange 26. Terminal end 59 of locking portion 56 extends to a location radially inward of terminal end 27 of flange 26. Locking portion 56 of hook 52 is allowed to pass through cutout 28 because radius R₄ of flange 26 at cutout 28 extends to a location radially inward of terminal end 59 of locking portion 56. Therefore, hook 52 is allowed to pass freely through cutout 28 when these two are aligned.

FIGS. 2-5 show insert 40 in the locked or captured position. As described above, insert 40 is placed on top of pot 20 such-that latches 52 pass through the corresponding cutouts 28. At this point, insert 40 is engaged with pot 20 as shown in FIG. 4, but has not been secured so as to function properly as a straining device. This may be described as the unlocked position. After engagement with pot 20, insert 40 may be rotated clockwise or counterclockwise. Nodes 54 provide a gripping surface to assist with manual rotation of insert 40. Preferably, insert 40 is rotated approximately 90 degrees such that latches 52 are substantially adjacent to handles 30. Insert 40 is now secured to pot 20 because, as shown in FIG. 4, terminal end 27 is disposed within crevice 58 such that hook 52 and locking portion 56 prevent substantially all axial movement of insert 40 along longitudinal axis 29 with respect to pot 20. This position may be described as the locked or captured position of strainer insert 40 with respect to pot 20. Although insert 40 is technically secured to pot 20 when a significant portion of hook 52 and locking portion 56 overlap a non-recessed portion of terminal end 27, it is preferred that insert 40 be rotated sufficiently (for example, 90 degrees as described above) such that hook 52 is significantly distant from cutout 28, thereby preventing accidental disengagement of insert 40 from pot 20 by inadvertent, minor rotation.

It should be noted that the latching mechanism of the present invention comprising flange 26, cutouts 28, and hook 52 allows rotation of insert 40 at all times during use of cooking system 10. It should also be understood that the user may rotate insert 40 through a significant portion of a full 360° rotation without being able to detach insert 40 from pot 20. Thus, the insert can remain in the locked or captured position while still permitting rotation of insert 40 relative to pot 20. In the embodiment shown, one latch 52 will travel almost 180 degrees from one cutout 28 to the other cutout 28, meanwhile remaining in the captured position relative to pot 20. However, as explained above, other numbers of recesses 28 and latches 52 may be employed. In such instances, the significant portion or arc of 360 degrees that a latch may travel before aligning with a recess 28 may be somewhat less than 180 degrees, such as a 45 degree arc.

Alternatively to the embodiment shown in the figures, strainer insert 40 may be configured in varying ways. First, insert 40 has any number of latches 52 with a corresponding (or greater) number of cutouts 28. However, it is preferred to have a small number of latches and cutouts to ensure that insert 40 remains secured to pot 20 throughout the use of cooking system 10 despite any inadvertent, minor rotation of insert 40.

Second, latches 52 may be located anywhere along the circumference of insert 40 relative to the plurality of small apertures 48 and large aperture 50. However, it is preferred that, when insert 40 is in the locked position, apertures 48 (used for straining) be located away from latches 52 and handles 30: With such a configuration, hot liquids that may be strained through apertures 48 will not contact latches 52 or handles 30, and thus will not undesirably heat portions of the cooking system 10 where manual contact may be required.

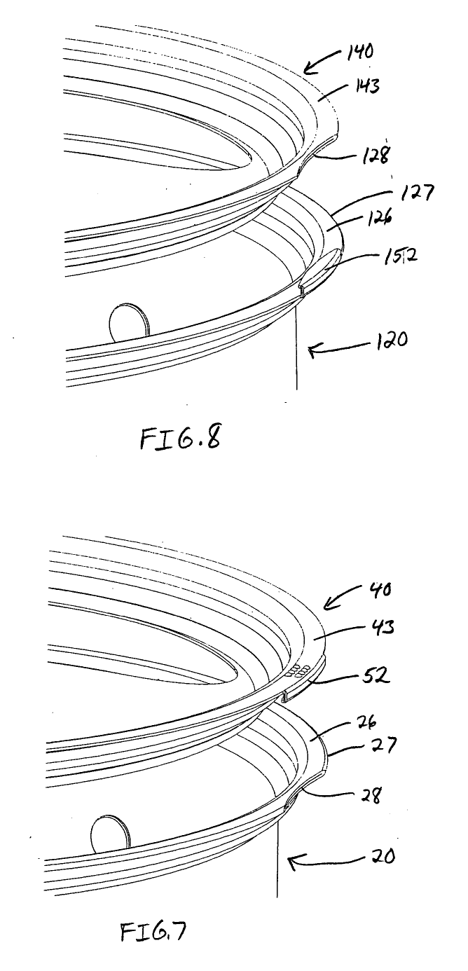

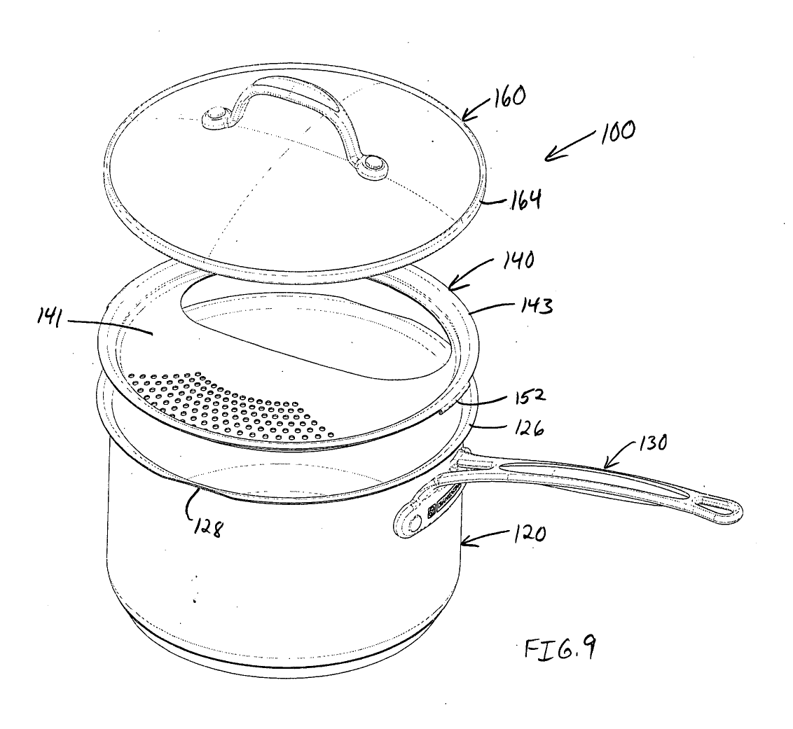

Referring now to FIGS. 7 and 8, yet another embodiment is shown and described. The latches or hooks 52 of the insert outer edge portion 43 are switched with the cutouts 28 of the pot flange 26 such that the latches are located on the pot rim and the cutouts are located in the insert rim. FIG. 7 shows the embodiment described above, while FIG. 8 shows an alternative pot 120 having a flange 126 with terminal end 127 and a hook or latch 152. FIG. 8 also shows an alternative strainer insert 140 having a rim portion 143 and a cutout 128. The capturing mechanism comprising rim portion 143, cutout 128, and latch 152 operates the same as the embodiment described above, with the exception that the physical location of the latches and cutouts are on opposite rim portions of the insert and pot.

The size of aperture 50 and the number of apertures 48 in strainer insert 40 may vary from those shown in FIGS. 1-3 above. FIG. 3 shows aperture 50 having an area equal to approximately 50% of insert body portion 41. Straining apertures 48 are shown covering an area equal to approximately 25% of body portion 41. These percentages may vary, but aperture 50 should be large enough such that a user may easily add or remove contents to and from pot 20, and such that a user may easily insert cooking utensils into pot 20 while strainer 40 is engaged to pot 20. Also, the size, shape, and area covered by region of straining apertures 48 should be such that the strained liquid may be drained without significant interference from insert 40 while also preventing the solid food contents of pot 20 from escaping pot 20 via aperture 50.

As discussed hereinbefore, it is to be understood that the engagement, support, and capturing means to secure strainer insert 40 to pot 20 described above are not meant to be limiting, but to be illustrative of a preferred embodiment. For example, flange 26 and rim portion 43 may include rubber gaskets or tongue and groove portions for additional or substitute support and capturing means. The latch and cutout mechanism for securing insert 40 to pot 20 may also be varied as long as the insert and pot work together to provide a combination cooker and strainer, and yet do not affect the use of the pot's lid, with or without the strainer. For example, the pot and lid could include corresponding threaded ends so that the insert could be screwed onto the rim of the pot. Preferably, the insert and pot are the only components needed to secure the insert to the pot, such as is achieved with the latch and cutout mechanism, although additional minor components may be added for securing the insert, such as clips or screws.

In an alternative embodiment to the insert, insert 40 may have a smaller, larger, or differently-shaped group of straining apertures instead of aperture 50, or in place of a portion of aperture 50, such straining apertures being know to one skilled in the art. With such a configuration, multiple straining options are provided to the user. Likewise, insert 40 may also include a pour spout, such a spout being known to one skilled in the art. Because insert 40 may be rotated freely by the user, meanwhile remaining secured to pot 20 in most positions (except those where latches 52 substantially align with cutouts 28), the user may easily switch between straining options or the pour spout by rotating insert 40.

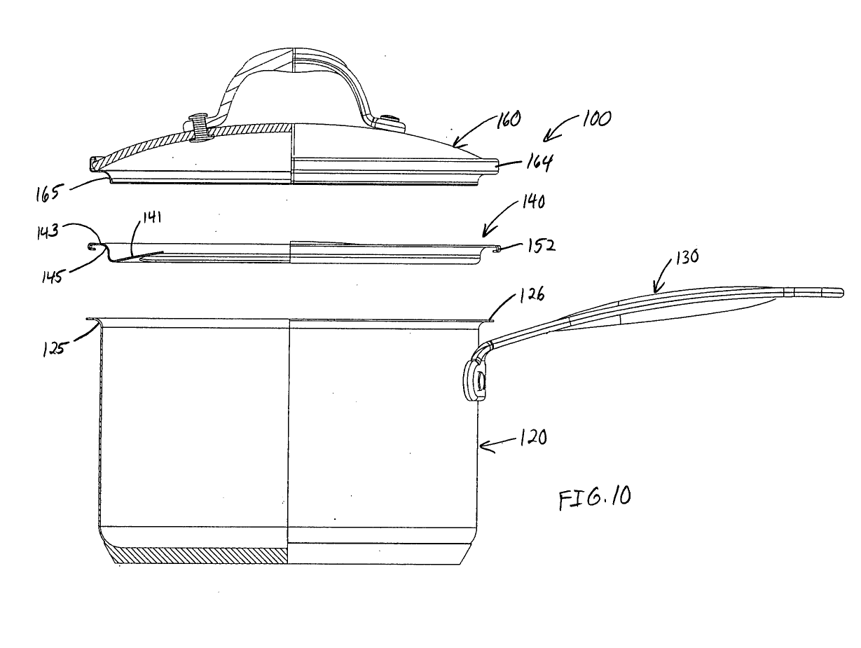

Now, with reference to FIGS. 9 and 10, a further alternative embodiment of cooking system 10 is shown. Cooking system 100 of FIG. 9 includes a pot 120 having a flange 126 and a different handle 130 as compared to the handles 30 of FIG. 1, a strainer insert 140 having a raised body portion 141 and a rim portion 143, and a lid 160 having a rim 164 with a lid flange 165. Pot 120 further includes cutouts 128 and insert 140 further includes hooks 152. The hook 152 and cutout 128 mechanism for securing insert 140 onto pot 120 is approximately the same as the previously described hook 52 and cutout 28 mechanism.

However, pot 120 does not include a shoulder near flange 126 such as shoulder 32 seen in FIG. 4. Instead, the rim of pot 120 simply flares out into flange 126. Likewise, strainer insert 140 does not include a shoulder such as shoulder 42, also seen in FIG. 4. When engaged with pot 120, rim portion 143 of insert 140 rests atop flange 126 of pot 120 and insert 140 is supported by pot 120.

Lid 160 has a rim 164, but unlike rim 64 as seen in FIG. 4, rim 164 includes a flange 165 extending below rim 164. When lid 164 is set onto either insert 140 or pot 120, rim 164 rests atop either rim portion 143 or flange 126, respectively. This is different than the embodiment shown in the previous Figures where rim 64 of lid 60 rests atop either shoulder 42 of insert 40 or shoulder 32 of pot 20. To stabilize lid 164 in terms of lateral movement with respect to insert 140 and/or pot 120, flange 165 abuts either insert 140 near curved portion 145 of rim 143, or pot 120 near curved portion 125 of flange 126.

The above discussion is meant to be illustrative of the principles and various embodiments of the present invention. Many variations and modifications of the invention and apparatus and methods disclosed herein are possible and are within the scope of the invention. Accordingly, the scope of protection is not limited by the description set out above, but is only limited by the claims which follow, that scope including all equivalents of the subject matter of the claims.

What is claimed is:

1. A cooking apparatus comprising:
a vessel having an annular rim;
an insert supported in rotational engagement with said vessel and comprising an annular rim portion engaging said vessel rim; and
wherein said insert rim is configured to rotationally engage said vessel rim such that when said insert is engaged with said vessel, said insert remains engaged with said vessel as said insert is rotated relative to said vessel in an arc not less than 45 degrees.

2. The cooking apparatus of claim 1 further comprising a lid and wherein said vessel has a shoulder having a diameter to support said insert and said lid simultaneously.

3. The cooking apparatus of claim 2 wherein said vessel shoulder supports said lid when said insert is not used.

4. The cooking apparatus of claim 1 wherein said insert further comprises a large aperture and a region of straining apertures.

5. A cooking apparatus comprising:
a vessel having an annular rim;
a strainer insert supported in rotational engagement with said vessel and comprising an annular rim portion engaging said vessel rim;
a latch member attached to and extending from a first of said rims and capturing the other of said rims;
at least one cutout in the other of said rims;
said insert detachable from said vessel when said latch member is aligned with said cutout; and
said insert being rotatable relative to said vessel when said latch member is aligned and when not aligned with said cutout.

6. The cooking apparatus of claim 5 further including a lid wherein said vessel has a shoulder having a diameter to support said insert and said lid simultaneously.

7. The cooking apparatus of claim 6 wherein said vessel shoulder supports said lid when said insert is not used.

8. The cooking apparatus of claim 5 wherein said latch comprises a hook.

9. The cooking apparatus of claim 7 wherein said hook is C-shaped in cross section.

10. The cooking apparatus of claim 5 wherein said other of said rims comprises a plurality of cutouts, said cutouts being space apart such that said other rim remains captured by said latch members as insert is rotated relative to said vessel in an arc not less than 45 degrees.

11. The cooking apparatus of claim 5 wherein said other rim comprises two cutouts approximately 180 degrees apart.

12. The cooking apparatus of claim 11 wherein said first rim further comprises a second latch member located approximately 180 degrees apart from said latch member.

13. The cooking apparatus of claim 5 wherein the number of said cutouts is greater than the number of said latch members.

14. The cooking apparatus of claim 5 wherein said strainer insert further comprises a large aperture and a region of straining apertures.

15. A cooking apparatus comprising:
a cooking vessel having a first rim;
an insert having a second rim resting upon said first rim, said insert comprising a region of straining apertures and an access aperture;
a cutout in at least one of said rims; and
a hook member extending from the other of said rims, said hook member having a crevice receiving the rim having said cutout and locking said insert to said vessel when said hook and said cutout are not aligned.

16. The cooking apparatus of claim 15 further comprising a lid supported on said insert and closing said vessel.

17. The cooking apparatus of claim 16 wherein said lid is free of apertures.

18. The cooking apparatus of claim 17 wherein said vessel has an annular inner shoulder having a diameter sized to support the outer edge of said lid.

19. The cooking apparatus of claim 15 wherein said insert is rotatable relative to said vessel when said hook member and said cutout are aligned and when not aligned.

20. The cooking apparatus of claim 19 further including a lid supported on said insert, said lid being rotatable relative to said insert.

21. The cooking apparatus of claim 19 further comprising a plurality of cutouts spaced apart such that said insert remains locked to said vessel by said hook members as said insert is rotated relative to said vessel in an arc not less than 45 degrees.

22. The cooking apparatus of claim 15 wherein said crevice is formed at a diameter greater than a diameter of said rim having said cutout.

23. The cooking apparatus of claim 22 wherein said rims have substantially the same outer diameter.

24. The cooking apparatus of claim 23 further comprising a lid and wherein said insert has an annular shoulder and said lid is supported on said shoulder.

25. A cooking apparatus comprising:
a vessel having an annular rim with cutouts;
an insert having a body with straining apertures, a shoulder, and a rim supported on said vessel rim; and
hook members having C-shaped cross sections disposed on said insert rim and engaging said vessel rim when said insert is positioned on said vessel such that said hook members are not aligned with said cutouts, said hook members being free of engagement with said vessel rim when said hook members are aligned with said cutouts.

26. The cooking apparatus of claim 25 further comprising a lid supported on said insert shoulder.

27. The cooking apparatus of claim 26 wherein said lid is see-through.

28. The cooking apparatus of claim 25 wherein said insert further comprises an access aperture.

29. The cooking apparatus of claim 28 wherein said access aperture is spaced apart from said straining apertures.

30. A method of cooking food items, the method comprising:
providing a pot having a rim with a plurality of cutouts;
providing a strainer insert having a rim with a plurality of hooks;
positioning the hooks in the cutouts and supporting the strainer insert on the pot;
rotating the strainer insert such that the hooks do not align with the cutouts so as to lock the strainer insert onto the pot;
cooking the food items; and
straining the food items.

31. The method of claim 30 further comprising:
realigning the hooks and cutouts; and
removing the strainer from the pot.
